(19) United States
(12) Patent Application Publication
(10) Pub. No.: US 2019/0091503 A1
(43) Pub. Date: Mar. 28, 2019

(54) DECONTAMINATING AGENT FOR CHEMICAL WARFARE AGENT (CWA), METHOD OF DECONTAMINATING CWA USING THE SAME AND PRODUCT INCLUDING THE SAME

(71) Applicants: AGENCY FOR DEFENSE DEVELOPMENT, Daejeon (KR); UNIVERSIDAD DE GRANADA, Granada (ES)

(72) Inventors: Sam Gon RYU, Daegu (KR); Myung Kyu PARK, Daegu (KR); Min Kun KIM, Seoul (KR); Jorge Rodriguez NAVARRO, Granada (ES); Rodrigo Gil San MILLAN, Granada (ES); Elena Lopez MAYA, Granada (ES); Elisa BAREA, Granada (ES)

(73) Assignees: AGENCY FOR DEFENSE DEVELOPMENT, Daejeon (KR); UNIVERSIDAD DE GRANADA, Granada (ES)

(21) Appl. No.: 16/109,798

(22) Filed: Aug. 23, 2018

(30) Foreign Application Priority Data
Aug. 24, 2017 (KR) 10-2017-0107281

(51) Int. Cl. A62D 3/30; B01D 53/02; B01J 20/22; B01J 20/02

(52) U.S. Cl. CPC A62D 3/30; B01D 53/02; B01J 20/226; B01J 20/0211; A62D 2101/02; B01D 2257/93; B01D 2253/204; B01D 2259/4583; B01J 20/0259

(57) ABSTRACT

Related are a chemical warfare agent (CWA) decontaminant, a method of decontaminating a CWA using the CWA decontaminant, and a product including the CWA decontaminant. The CWA decontaminant may include a metal-organic framework (MOF) including at least one metallic compound among metal hydroxide, metal hydride, metal acetate, metal methoxide, and metal oxide, and the at least one metallic compound may be dispersed either on a surface of the MOF or in pores of the MOF, or both.

### CROSS-REFERENCE TO RELATED APPLICATION(S)

This application claims the priority benefit of Korean Patent Application No. 10-2017-0107281 filed on Aug. 24, 2017, in the Korean Intellectual Property Office, the disclosure of which is incorporated herein by reference for all purposes.

### BACKGROUND

### 1. Field

One or more example embodiments relate to a chemical warfare agent (CWA) decontaminant, a method of decontaminating a CWA using the CWA decontaminant, and a product including the CWA decontaminant.

### 2. Description of Related Art

A potential exposure to chemical warfare agents (CWAs) used to prepare gases for wars and other toxic agents containing industrial toxic substances poses a permanent threat to military personnel and civilian alike. Such agents include, for example, generally-known nerve agents such as soman (militarily designated as GD), tabun (GA), sarin (GB), chlorosarin (GF), and O-ethyl S-(2-diisopropylamino)ethyl methylphosphonothioate (VX), and other analogous substances or derivatives thereof. These CWAs are generally sprayed in a form of fine aerosol fumes, and may thus rapidly permeate into a body when they are absorbed through inhalation or contact with skin or an eye, and also be deposited on the surface of various types of military equipment including military uniforms and weapons, causing them to be incapacitated. When the surface of such equipment is contaminated with a highly poisonous CWA, the CWA needs to be removed rapidly to minimize risk of contact. In addition to the CWAs described above, industrial chemicals may also need such decontamination or detoxification. Thus, there is a growing need for technology for effectively decontaminating precision equipment and surfaces that are contaminated with various toxic substances including, for example, pesticides that may cause paralysis of a nerve system including organophosphates such as parathion, paraoxon, and malathion, and other toxic substances that are not organophosphates.

A most generally used decontaminant for protection against nerve agents is decontamination solution-2 (DS-2). DS-2 is currently being used in many parts of the world including ones where American forces are stationed. It contains 2% sodium hydroxide (NaOH), 28% ethylene glycol monomethyl ether, and 70% diethylenetriamine, in weight ratio. Although DS-2 is an effective decontaminant for organophosphous nerve agents, it is highly poisonous, combustible, and corrosive. It also produces toxic by-products while decontaminating. In addition, diethylenetriamine, one of the main substances of DS-2, in particular, is known to be a teratogen, and DS-2 may thus be potentially harmful to health when it is used or produced. Furthermore, using DS-2 for decontamination increases an amount of military resources and logistics because surfaces decontaminated by DS-2 need to be washed off with water after the decontamination process is performed and it is thus necessary to store or transport a great amount of water in or to a place where the decontamination is needed.

In related arts, published technology provides a method of enhancing reactivity of an alumina-based reactive adsorbent powder, and a compound of aluminum oxide, or alumina, and magnesium monoperoxyphthalate (MMPP). Other published technology provides, as a reactive sorbent, a metal-substituted zeolite adsorbent. These provided reactive sorbents may absorb CWAs rapidly, or remove toxicity of the absorbed CWAs. The reactive sorbents may prevent the CWAs from escaping therefrom. Although they are fast in absorbing CWAs from contaminated surfaces or removing them from the surfaces, they are slow in allowing the absorbed CWAs to degrade.

Recently, metal-organic frameworks (MOFs), zirconium (Zr) MOF, in particular, are receiving a great deal of attention as CWA decontaminants since it has been proved that they accelerate a rate of hydrolysis of nerve agents. However, this acceleration capability has only been proved by experiments conducted in the presence of basic buffer solution, for example, ethylmorpholine, that may neutralize acidic substances produced by degradation, and has not been completely proved yet in connection with actual applications.

Thus, there is a desire for a decontaminant that may absorb nerve agents immediately after the nerve agents make contact under actual environmental conditions including, for example, temperature and humidity conditions as in actual field warfare, and that may immediately decontaminate a surface and the like contaminated with such toxic agents.

### SUMMARY

One or more example embodiments provide a chemical warfare agent (CWA) decontaminant that has excellent adsorption and degradation capabilities, that may be used under an actual environmental condition, and that has an enhanced degradation reaction rate and an enhanced decontamination effect.

One or more example embodiments provide a method of decontaminating a CWA using a CWA decontamninant.

One or more example embodiments provide a method of preparing a CWA decontaminant.

One or more example embodiments provide a composition of a CWA decontaminant, and the composition may include the CWA decontaminant.

One or more example embodiments provide a product including a composition of a CWA decontaminant.

Subjects to be solved by the present disclosure are not limited to the above-mentioned description, and any other subjects not mentioned so far will be clearly appreciated from the following description.

According to an aspect, there is provided a CWA decontaminant including a metal-organic framework (MOF). The MOF may include at least one metallic compound among metal hydroxide, metal hydride, metal acetate, metal methoxide, and metal oxide. The at least one metallic compound may be dispersed either on a surface of the MOF or in pores of the MOF, or both.

The metallic compound may include at least one among Mg, Ca, Sr, Ba, and Zn.

The metallic compound may include at least one magnesium salt among magnesium hydroxide, magnesium hydride, magnesium acetate, and magnesium methoxide.

A central metal of the MOF may include either one or both of an element and an ion of at least one metal among Zr, Ce, Fe, Ti, Cu, Hf, V, and Sb.

The MOF may include at least one backbone structure among MOF-808, NU-1000, UiO-66, UiO-66-X in which X is NH₂, NO₂, or (OH)₂, UiO-67, and UiO-67-X in which X is NH₂, NO₂, or (OH)₂.

The metallic compound may be present in an amount of 1 through 50 parts by weight based on 100 parts by weight of the MOF.

A CWA may include at least one among soman, tabun, sarin, cyclosarin, O-ethyl S-(2-diisopropylamino)ethyl methylphosphonothioate (VX), parathion, paraoxon, malathion, and derivatives thereof.

According to another aspect, there is provided a method of decontaminating a CWA, the method including preparing a CWA decontaminant and degrading the CWA by contacting the CWA decontaminant with the CWA being in a liquid or gas phase.

The degrading of the CWA may be performed at a temperature 0° C. to 200° C.

According to another aspect, there is provided a method of preparing a CWA decontaminant, the method including preparing a metallic compound solution by mixing a metallic compound and a solvent, preparing a MOF suspension by mixing a MOF and a solvent, mixing the metallic compound solution and the MOF suspension, and separating a powder from a mixture obtained by the mixing of the metallic compound solution and the MOF suspension and drying the powder.

Each of the solvents may include at least one among water, acetone, benzyl alcohol, methanol, ethanol, isopropanol, n-propanol, n-butanol, tert-butanol, acetonitrile, ether, N-methyl-2-pyrrolidone (NMP), dimethylfonnamide (DMF), dimethylacetamide (DMAc), xylene, benzene, chloroform (CHCl₃), toluene, tetrahydrofuran (THF), glycerin, ethylene glycol, dimethylpyrrolidone, cyclohexane, and dimethyl sulfoxide.

According to another aspect, there is provided a composition of a CWA decontaminant, the composition including the CWA decontaminant, and a solvent.

According to another aspect, there is a product including a composition of a CWA decontaminant.

The product may be a gas mask canister or a gas filter of collective protection equipment.

The product may be formed of a fiber.

The fiber may be combined with the composition by either one or both of impregnating the fiber with the composition and coating the fiber with the composition.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1A is a flowchart illustrating an example of a method of preparing a chemical warfare agent (CWA) decontaminant according to an example embodiment;

FIG. 1B is a flowchart illustrating another example of a method of preparing a CWA decontaminant according to an example embodiment;

FIG. 2 is a flowchart illustrating a method of decontaminating a CWA using a CWA decontaminant according to an example embodiment;

FIGS. 3A through 3D are graphs showing X-ray diffraction analysis results of a CWA decontaminant according to Experimental Example 1;

FIGS. 4A through 4D are graphs showing nitrogen isotherm adsorption curves of a CWA decontaminant according to Experimental Example 1;

FIGS. 5A through 5D are graphs showing degradation rates of diisopropylfluorophosphate (DIFP) by a catalytic reaction using a CWA decontaminant according to Experimental Example 2;

FIGS. 6A and 6B are graphs showing degradation rates of DIFP by a catalytic reaction using a CWA decontaminant according to Experimental Example 2;

FIGS. 7A through 7D are graphs showing degradation rates of GD by a catalytic reaction using a CWA decontaminant according to Experimental Example 2; and

FIGS. 8A through 8D are graphs showing degradation rates of VX by a catalytic reaction using a CWA decontaminant according to Experimental Example 2.

### DETAILED DESCRIPTION

Hereinafter, example embodiments will be described in detail with reference to the accompanying drawings. When it is determined detailed description related to a related known function or configuration they may make the purpose of the present disclosure unnecessarily ambiguous in describing the present disclosure, the detailed description will be omitted here. Also, terminologies used herein are defined to appropriately describe the example embodiments of the present disclosure and thus may be changed depending on a user, the intent of an operator, or a custom of a field to which the present disclosure pertains. Accordingly, the terminologies must be defined based on the following overall description of this specification.

According to an example embodiment, a decontaminant for a chemical warfare agent (CWA) may be provided. In the present disclosure, the decontaminant for the CWA may be referred to as a “CWA decontaminant.” According to an example embodiment, the CWA decontaminant may accelerate a catalytic reaction of a metal-organic frame (MOF) and enhance degradation and elimination capabilities of the CWA decontaminant, by dispersing a metallic compound in the MOF.

According to an example embodiment, the CWA decontaminant may include a MOF including a metallic compound that is dispersed either on a surface of the MOF or in pores of the MOF, or both.

The metallic compound may be dispersed in the MOF and combined with the MOF by impregnation, doping, substitution, and the like. The metallic compound may interact with the MOF to increase catalytic properties of the MOF. The metallic compound may include, for example, at least one among metal hydroxide, metal hydride, metal acetate, metal methoxide, and metal oxide, and the metallic compound may or may not autonomously have decontamination properties against a CWA.

The metallic compound may include, for example, at least one among Mg, Ca, Sr, Ba, and Zn, and may desirably include at least one among magnesium hydroxide, magnesium hydride, magnesium acetate, and magnesium methoxide.

For example, the metallic compound may be present in an amount of 1 to 50 parts by weight based on 100 parts by weight of the MOF. When the amount of the metallic compound is within the above-mentioned range, the metallic compound may improve catalytic properties of the MOF through an interaction with the MOF, to enhance a degradation capability and a degradation reaction rate of the CWA decontaminant.

The MOF may have an excellent adsorption capability due to a relatively wide specific surface area, and may also have catalytic properties using a metal ion. The MOF may perform decontamination by catalytically degrading a target compound such that the target compound is decontaminated to a harmless material due to an excellent catalytic reactivity with respect to the target compound through the interaction with the metallic compound.

A central metal of the MOF may include, for example, either one or both of an element and an ion of at least one metal among Zr, Ce, Fe, Ti, Cu, Hf, V, and Sb.

The MOF may include, for example, at least one backbone structure among MOF-808, MOF-801, NU-1000, UiO-66, UiO-66-X in which X is H, NH₂, NO₂, or (OH)₂, UiO-67, and UiO-67-X in which X is H, NH₂, NO₂, or (OH)₂.

The CWA may be, for example, a target compound to be catalytically decontaminated. The CWA decontaminant may be used to decontaminate all CWAs known in a technological field of the present disclosure without limitation. A CWA may include, for example, choking agents, nerve agents, blood agents, blister agents, psychotomimetic agents, riot control agents, and the like. The CWA may include at least one among soman, tabun, sarin, cyclosarin, O-ethyl S-(2-diisopropylamino)ethyl methylphosphonothioate (VX), and derivatives thereof. Also, in example embodiments, the CWA is not limited to the target compound to be catalytically decontaminated, and the CWA decontaminant may provide a function of decontaminating a compound having toxicity to a human body, for example, organophosphorus pesticides such as parathion, paraoxon, malathion, and derivatives thereof.

For example, the CWA decontaminant may include at least one MOF including the metallic compound that is dispersed either on a surface of the MOF or in pores of the MOF, or both. The metallic compound and the MOF may be mixed at a mass ratio of 1:1 to 1:99, to form a CWA decontaminant having a catalytic activity for various compounds. Thus, the CWA decontaminant may show an excellent decontamination function by reacting immediately when the CWA decontaminant is in contact with an unspecific target compound to be catalytically decontaminated, or various known target compounds to be catalytically decontaminated.

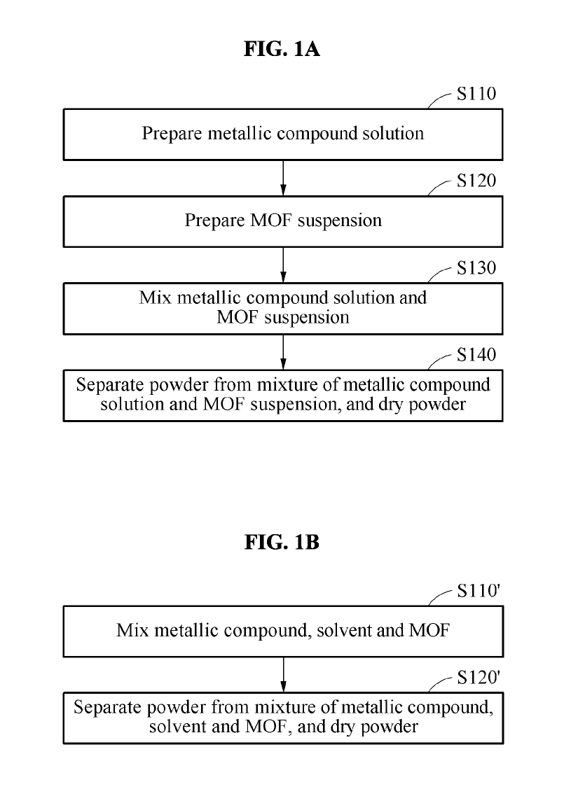

The present disclosure relates to a method of preparing a CWA decontaminant. According to an example embodiment, referring to FIG. 1A, the method of preparing the CWA decontaminant may include operation S110 of preparing a metallic compound solution, operation S120 of preparing a MOF suspension, operation S130 of mixing the metallic compound solution and the MOF suspension, and operation S140 of separating a powder from a mixture of the metallic compound solution and the MOF suspension and drying the powder.

In operation S110, the metallic compound solution may be prepared by mixing a metallic compound and/or a metallic compound precursor and a solvent. The metallic compound solution may be a suspension, or a solution in which the metallic compound and/or the metallic compound precursor is dissolved. In the present disclosure, the suspension and the solution may be referred to as a “metallic compound solution”.

As the solvent, any solvent capable of dissolving the metallic compound may be used without limitation. The solvent may include, for example, at least one among water, acetone, benzyl alcohol, methanol, ethanol, isopropanol, n-propanol, n-butanol, tert-butanol, acetonitrile, ether, N-methyl-2-pyrrolidone (NMP), dimethylformamide (DMF), dimethylacetamide (DMAc), xylene, benzene, chloroform (CHCl₃), toluene, tetrahydrofuran (THF), glycerin, ethylene glycol, dimethylpyrrolidone, cyclohexane, and dimethyl sulfoxide. For example, the metallic compound may be the same as that of the aforementioned CWA decontaminant.

In operation S120, the MOF suspension in which a MOF is dispersed may be prepared by mixing the MOF and a solvent. The solvent in operation S120 may be identical to or different from that of operation S110, and may be the same as that of the aforementioned solvent.

In an example, in operation S130, the metallic compound solution and the MOF suspension may be mixed at a temperature of 20° C. to 30° C., and dispersion of the metallic compound either on a surface of the MOF or in pores of the MOF, or both may be induced. For example, an ultrasonic wave and/or a stirrer may be used to mix the metallic compound solution and the MOF suspension.

In another example, primary mixing may be performed at a temperature of 20° C. to 30° C., followed by secondary mixing at a temperature of 40° C. to 100° C. For example, the primary mixing may induce a metallic compound and a MOF to be uniformly mixed and dispersed by stirring and/or processing with an ultrasonic wave. The secondary mixing may further promote dispersion and/or impregnation of the metallic compound into pores of the MOF.

For example, in operation S130, primary mixing may be performed for 1 hour (hr) to 10 hrs, and secondary mixing may be performed for 1 hr to 10 hrs.

In operation S140, a powder may be filtered and centrifuged from the mixture of the metallic compound solution and the MOF suspension, and the powder may be dried.

For example, drying may be performed at a temperature of 40° C. to 200° C. for 1 hr or more, or 1 hr to 40 hrs and may be performed in an atmosphere, such as a vacuum state, inert gas, air, and the like.

According to another example embodiment, referring to FIG. 1B, operation S110′ of mixing a metallic compound, a solvent, and a MOF, and operation S120′ of separating a powder from a mixture of the metallic compound, the solvent, and the MOF, and drying the powder may be included. Operations S110′ and S120′ may be performed in the same manner as in operations S130 and S140 of FIG. 1A.

The present disclosure relates to a composition of a CWA decontaminant. According to an example embodiment, the composition may include a CWA decontaminant and a solvent.

For example, the solvent may disperse and/or dissolve the CWA decontaminant instead of inhibiting a decontamination effect of the composition. The solvent may be properly selected based on an application field of the composition, and may include, for example, at least one among water, acetone, benzyl alcohol, methanol, ethanol, isopropanol, n-propanol, n-butanol, tert-butanol, acetonitrile, ether, N-methyl-2-pyrrolidone (NMP), dimethylformamide (DMF), dimethylacetamide (DMAc), xylene, benzene, chloroform (CHCl₃), toluene, tetrahydrofuran (THF), glycerin, ethylene glycol, dimethylpyrrolidone, cyclohexane, and dimethyl sulfoxide.

The composition of the CWA decontaminant may provide an effect of decontaminating the CWA within various temperature ranges. The above-mentioned decontamination effect may show at a temperature of 0° C. or more, 0° C. to 200° C., 0° C. to 150° C., 1° C. to 100° C., 5° C. to 60° C., 5° C. to 40° C., 10° C. to room temperature, or room temperature.

The composition of the CWA decontaminant may be in either one or both of a liquid form and a solid form and may be prepared in an appropriate form based on an application field. For example, the composition may be, a powder, a granule, a suspension, a slurry, an emulsion, a paste, an aerosol, a spray, and the like.

For example, an appropriate additive, and the like may be added to the composition of the CWA decontaminant based on an application field, which is not described in detail herein.

The present disclosure relates to a product including a composition of a CWA decontaminant. According to an example embodiment, the product may include, for example, at least one of a substrate combined with the composition of the CWA decontaminant by impregnating or coating the substrate with the composition, a molded body that is molded together with the composition, and a formulation including either one or both of liquid and solid with the composition may be included. The formulation may be, for example, a powder, a granule, a suspension, a slurry, an emulsion, a paste, an aerosol, a spray, and the like.

According to an example embodiment, any substrate to which the composition of the CWA decontaminant is applicable may be used as the substrate without limitation. For example, the substrate may be a porous substrate or a non-porous substrate and may include, but is not limited to, at least one among a fiber, a wood, a cellulose paper, a fabric, a metal, a polymer resin, a glass powder, a sheet, a film, or a bead.

For example, the substrate and the molded body may be coated, impregnated, or molded by applying a coating method, an impregnation method, or a molding method that are applicable in a technical field of the present disclosure, which is not described in detail herein. For example, the molding method may be performed after the composition of the CWA decontaminant and a target to be molded are mixed. Also, when the target to be molded is injection molded, the composition of the CWA decontaminant and the target to be molded are injected and molded together.

As the fiber, any fiber to which the composition of the CWA decontaminant is applicable may be used without limitation. The fiber may include, for example, but is not limited to, a synthetic fiber, a natural fiber, and a glass fiber. The synthetic fiber may include, for example, a urethane fiber, a polypropylene fiber, a polyester fiber, a poly arylene sulfide fiber, a polyethylene fiber, a polyamide fiber, a polylactic acid fiber, and the like. The natural fiber may include, for example, a vegetable fiber such as cotton, linen, rayon, and the like, an animal fiber such as silk, wool, and the like, and a mineral fiber such as asbestos, and the like.

The product may be a product for decontaminating a target compound to be catalytically decontaminated, or a product having the above-mentioned decontamination function. For example, the product may be applicable to sportswear, trainers, a climbing suit, a tent, mountaineering boots, gloves, boots, a mask, a cap or hat, a helmet, a gas mask of a chemical filter, a hazmat suit, a gas mask canister, a gas filter of collective protection equipment, a protective suit and equipment, such as a fire proximity suit and equipment, pharmaceuticals (for example, a type of powder, liquid, emulsion, capsule, and the like), a medical appliance, such as a gauze, a cotton ball, and a bandage, and the like, cosmetics, a sensor, a filter, an air freshener, an air purifier, and the like, however, is not limited thereto.

The present disclosure relates to a method of decontaminating a CWA using a CWA decontaminant. According to an example embodiment, in the method, when a CWA decontaminant according to an example embodiment is applied to be in contact with a CWA within various temperature ranges, an immediate degradation reaction may occur, and thus an excellent decontamination effect may be provided.

According to an example embodiment, referring to FIG. 2, a method of decontaminating a CWA using a CWA decontaminant may include operation S210 of preparing a CWA decontaminant and operation S220 of degrading a CWA by contacting the CWA decontaminant with the CWA.

In operation S210, the CWA decontaminant may be prepared. The CWA decontaminant may be prepared as the above-described composition and/or product. For example, the CWA decontaminant may be prepared as a powder, a granule, a suspension, a slurry, an emulsion, a paste, an aerosol, a spray, a film combined with the composition by coating or impregnating the film with the composition or the CWA decontaminant, and a molded body, such as a fiber, a bead, and the like.

In operation S220, the CWA that is in at least one state of a liquid phase, a gas phase, and a solid phase may be degraded by contacting the CWA decontaminant.

For example, operation S220 may be performed at a temperature of 0° C. or more, 0° C. to 200° C., 0° C. to 150° C., 1° C. to 100° C., 5° C. to 60° C., 5° C. to 40° C., and 10° C. to room temperature. The CWA may be degraded and decontaminated within various temperature ranges, and thus an excellent decontamination function may be provided in connection with various fields and under various temperature conditions when a decontamination is required.

For example, in operation S220, the CWA may be degraded by up to 100% within 1 second (sec), 10 secs, 30 secs, 1 minute (min), 5 mins, 5 mins to 1 hr, 5 mins to 2 hrs, or 5 mins to 5 hrs when the CWA decontaminant is in contact with the CWA.

### Preparation Example 1

### Synthesis of UiO-66: [Zr₆O₄(OH)₄(BDC)₆]

An UiO-66 sample was prepared using a large capacity reflux system with reference to a method of [Ameloot, R., Aubrey, M., Wiers, B. M., GoA. P., Patel, S. N., Balsara, N. P., & Long, J. R. (2013). Ionic conductivity in the metal-organic framework UiO-66 by dehydration and insertion of lithium tert-butoxide. Chemistry—A European Journal, 19(18), 5533-5536]. A mixture of zirconium tetrachloride (ZrCl₄), terephthalic acid (H₂BDC), HCl, and N, N-dimethylformnnamide (DMF) at a ratio of 25 mmol:50 mmol:50 mmol:150 mL was added to a round bottom flask, and allowed to react with stirring for 16 hrs by heating to a temperature at which the mixture was refluxed. A white material generated by the reaction was collected by filtration, washed three times with DMF to remove unreacted H₂BDC, washed three times with acetone, and dried at room temperature. An activation process of a synthesized material was performed under vacuum at 250° C. for 12 hrs or more.

### Preparation Example 2

### Synthesis of MOF-808: [Zr₆O₄(OH)₄(BTC)₂(HCOO)₆]

A MOF-808 sample was prepared using a large capacity reflux system with reference to a method of [Jiang, J., GaF., Zhang, Y., Na, K., Yaghi, O. M., & Klemperer, W. G. (2014). Superacidity in sulfated MetalOrganic framework-808. Journal of the American Chemical Society, 136(37), 12844-12847. doi:10.1021/ja507119n]. Benzene-1,3,5-tricarboxylic acid (BTC, 1.1 g, 5 mmol) and ZrOCl₂.8H₂O (1.6 g, 5 mmol) were dissolved in a mixture of DMF and formic acid (200 mL/200 mL), which was added to a round bottom flask and left at 120° C. for 2 days. A reaction product resulting from the reaction was washed three times with DMF and washed three times with acetone. An activation process of a synthesized material was performed under vacuum at 150° C. for 12 hrs or more.

### Preparation Example 3

### Synthesis of Ce-UiO-66 (or Ce-UiO-66-BDC): [Ce₆(O)₄(OH)₄(BDC)₆]

A Ce-UiO-66-BDC that is a cerium-based MOF was magnified eight times and prepared with reference to a method of [Lammert, M., Wharmby, M. T., Smolders, S., Bueken, B., Lieb, A., Lomachenko, K. A., Stock, N. (2015). Cerium-based metal organic frameworks with UiO-66 architecture: Synthesis, properties and redox catalytic activity. Chem. Commun., 51(63), 12578-12581]. Pyrex glass reaction tubes were used. 1,4-benzenedicarboxylic acid (H₂BDC, 283.2 mg, 1.7 mmol) was dissolved in DMF (9.6 mL), followed by an aqueous solution of ammonium cerium(IV) nitrate ((NH₄)₂Ce(NO₃)₆, 3.2 mL, 0.5333M) was slowly added thereto. A reactant mixture was heated while being stirred at 100° C. for 15 mins. A light-yellow precipitate was centrifuged, and the precipitate was washed two times with 4 mL of DMF and washed four times with 4 mL of acetone. A solid product was dried in the air at 70° C., and an activation process of the solid product was performed under vacuum at 150° C. for 12 hrs or more.

### Preparation Example 4

### Synthesis of Ce-MOF-808: [Ce₆(O)₄(OH)₄(BTC)₂(OH)₆(H₂O)₆]

A Ce-UiO-66-BDC that is a cerium-based MOF was magnified eight times and prepared. Benzene-1,3,5-tricarboxylic acid (H₃BTC, 179.2 mg, 848 mmol) was added to a glass reactor, 9.6 mL of DMF was added thereto, and an aqueous solution of (NH₄)₂Ce(NO₃)₆ (3.2 mL, 0.533M) was slowly added thereto. A reactant mixture was heated while being stirred at 100° C. for 15 mins. A precipitate was centrifuged, washed three times with 4 mL of DMF, washed three times with 4 mL of dimethyl sulfoxide (DMSO), and washed once with 4 mL of THF. A solid product was dried in the air at 70° C. An activation process of a synthesized material was performed under vacuum at 120° C. for 8 hrs to prevent a structure of the synthesized material from being destroyed.

### Examples 1 to 4

### Preparation of Magnesium Hydroxide-Doped MOF: MOF@Mg(OH)₂

As shown in Table 1, 100 mg of each of MOFs prepared and activated in Preparation Examples 1 to 4 was added to 5 mL of THF, to prepare a suspension. 15 mg of Mg(OH)₂ was added to the suspension. A mixture was stirred at room temperature for 1 hr, and then centrifuged. Supernatants were removed, and solid products were collected and dried in the air at 70° C.

TABLE 1

| | Example 1 | Example 2 | Example 3 | Example 4 |
|---|---|---|---|---|
| MOF@Mg(OH)₂ | UiO- | MOF- | Ce-UiO- | Ce-MOF- |
| | 66@Mg(OH)₂ | 808@Mg(OH)₂ | 66@Mg(OH)₂ | 808@Mg(OH)₂ |

### Comparative Examples 1 to 4

### Preparation of LiOBu-Doped MOF: MOF@LiOBu

As shown in Table 2, LiOBu-doped MOFs were prepared by doping the MOFs prepared and activated in Preparation Examples 1 to 4 with LiOBu with reference to [E. LoC. Montoro, L. M. RodriS. D. Aznar-Cervantes, A. A. Lozano-PeJ. L. CeniE. Barea, J. A. R. Navarro. Textile-metal-organic framework composites as self-detoxifying filters for chemical warfare agent Angew. Chem. Int. Ed., 2015, 54, 6790-6794].

TABLE 2

| | Comparative | Comparative | Comparative | Comparative |
|---|---|---|---|---|
| | Example 1 | Example 2 | Example 3 | Example 4 |
| MOF@LiOBu | UiO- | MOF- | Ce-UiO- | Ce-MOF- |
| | 66@LiOBu | 808@LiOBu | 66@LiOBu | 808@LiOBu |

### Experimental Example 1

### Analysis Result of Physical Properties

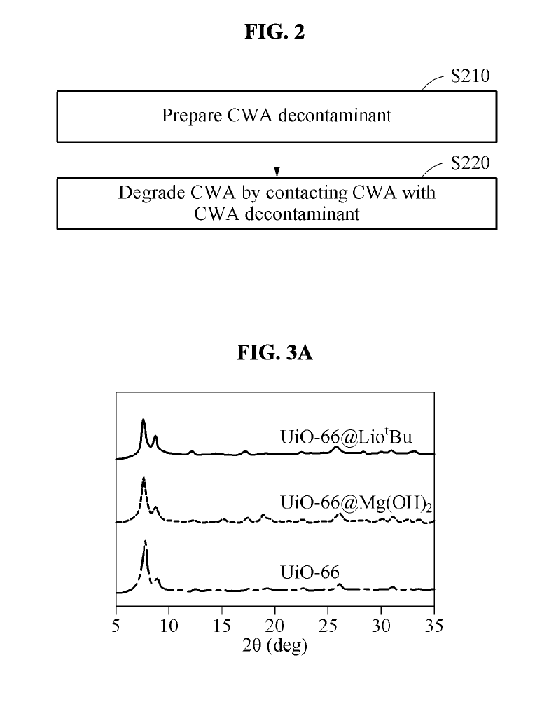

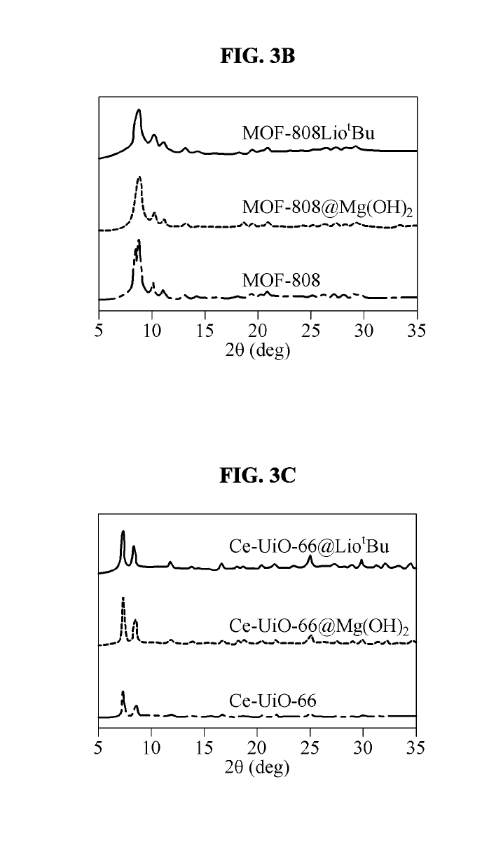

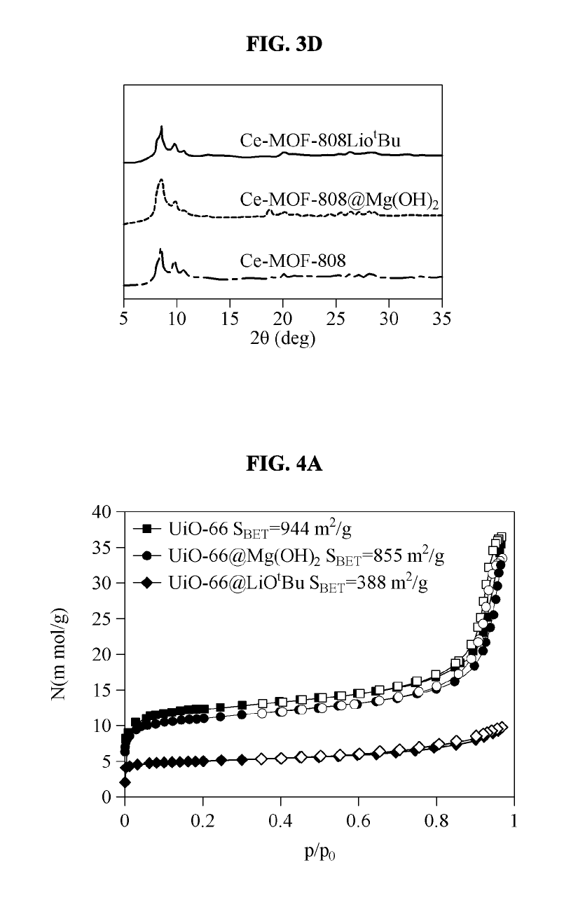

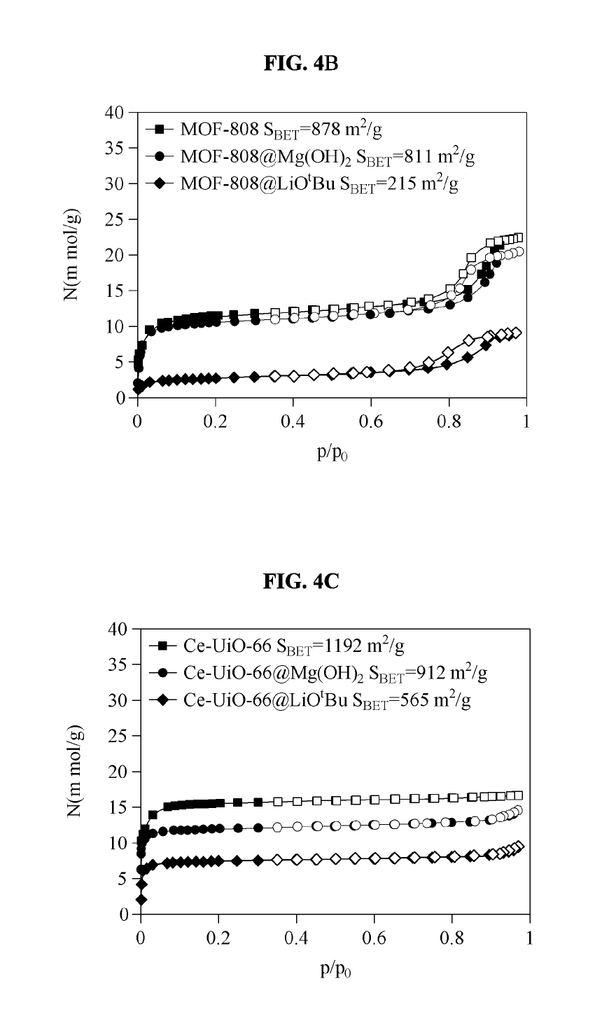

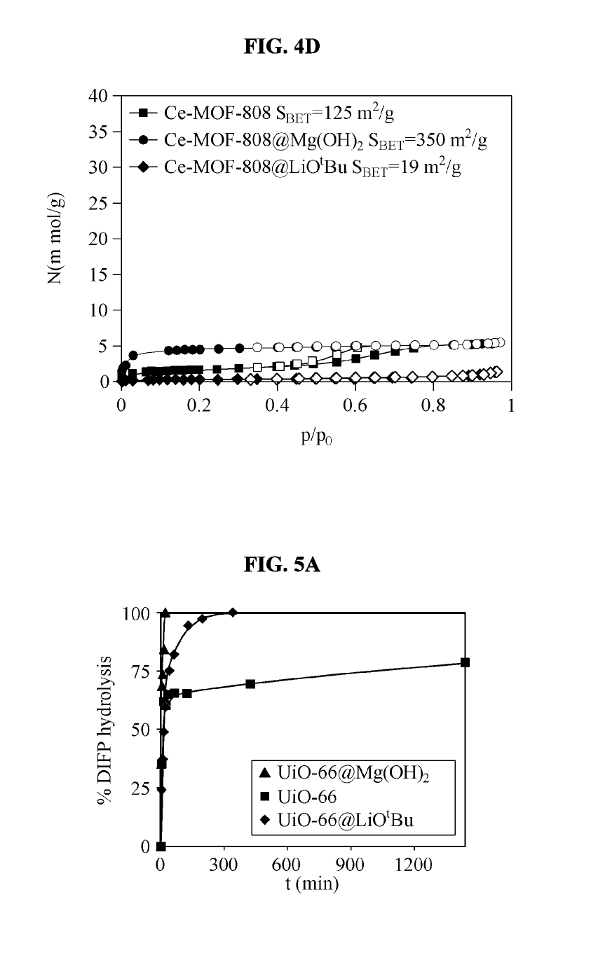

Powder x-ray diffraction (PXRD) patterns and nitrogen isotherm adsorption curves of MOF powders obtained in Preparation Examples 1 to 4, Examples 1 to 4, and Comparative Examples 1 to 4 were measured. Measurement results are shown in FIGS. 3A through 3D and 4A through 4D.

Referring to FIGS. 3A through 3D, crystals of the MOFs were maintained in the PXRD patterns without a change even after the MOFs were doped with Mg(OH)₂, and a peak specific to Mg(OH)₂ is not shown in the Mg(OH)₂-doped MOF, and thus a formation of a complex material may be predicted. Also, it may be confirmed based on the nitrogen isotherm adsorption curves of FIGS. 4A through 4D that a nitrogen adsorption capability hardly changed. Thus, it may be found that the Mg(OH)₂-doped MOF is stable and is not affected by environmental conditions. Also, although not shown in FIGS. 4A through 4D, similar nitrogen isotherm adsorption curves may be provided even though the Mg(OH)₂-doped MOF according to the present disclosure is left in the air for 1 month or more, or 1 year or more. Thus, the Mg(OH)₂-doped MOF may be excellent in stability under environmental conditions.

LiOBu-doped MOF exhibits properties similar to those of the Mg(OH)₂-doped MOF in the PXRD patterns of FIGS. 3A through 3D. However, referring to the nitrogen isotherm adsorption curves of FIGS. 4A through 4D, it may be found that since a nitrogen adsorption capability of the LiOBu-doped MOF significantly decreased, the LiOBu-doped MOF may be easily affected by environmental conditions.

### Experimental Example 2

### Verification of Decontamination Efficiencies for CWA Simulant and CWA

1) Decontamination Experiment of Diisopropyl Fluorophosphate (DIFP) as CWA Simulant

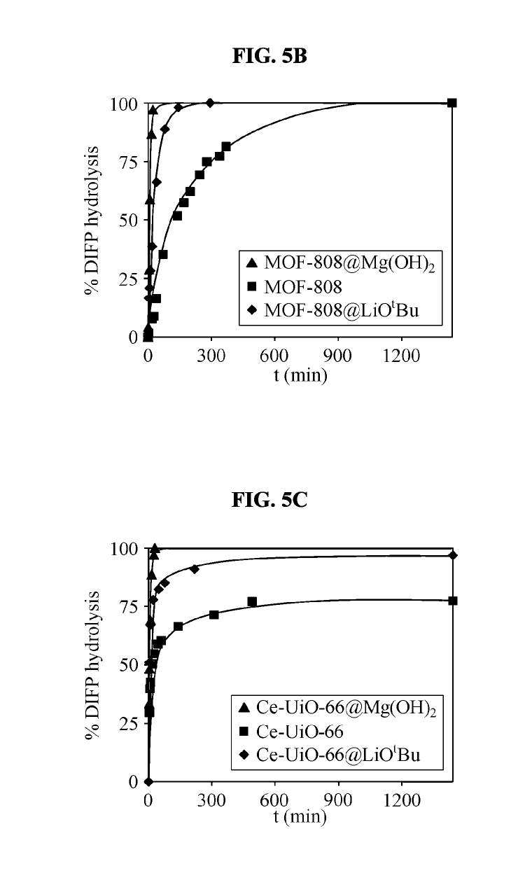

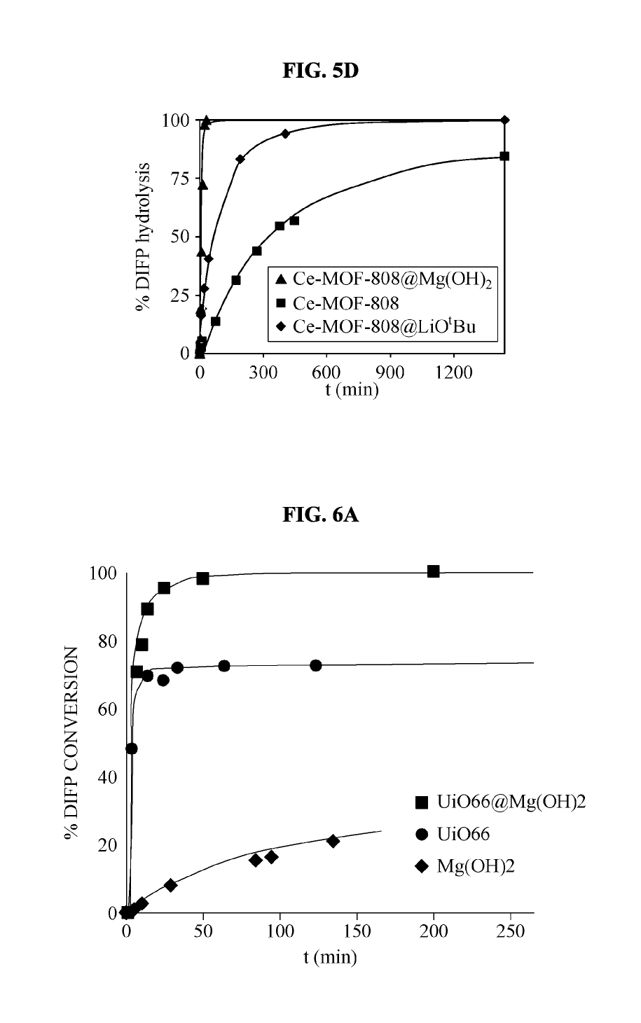

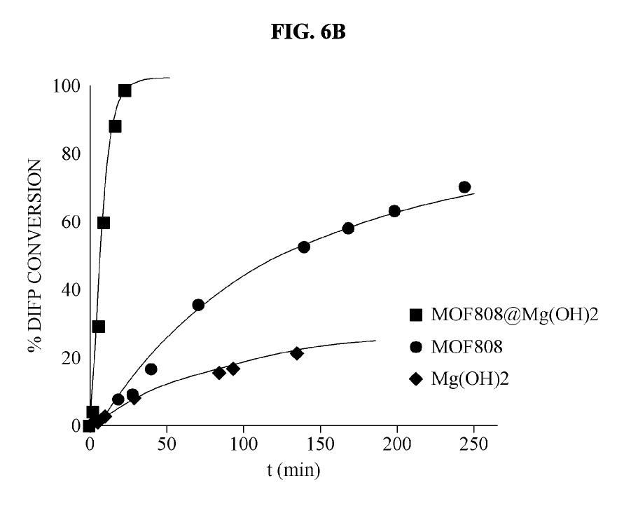

To verify a degradation rate of DIFP that is a nerve agent simulant, 20 mg of each of the MOFs of Preparation Examples 1 to 4, Examples 1 to 4 and Comparative Examples 1 to 4 and 20 mg of pure Mg(OH)₂ were added to a 2.0 ml glass vial, 0.5 mL of distilled water was added thereto, and mixed. 2.5 μl of DMSO as an internal standard material for a gas chromatography (GC) was added to each vial, and 2.5 μl of DIFP was spiked using a microsyringe. Thereafter, vortexing using a vortex mixer was performed for about 2 mins until the contents were well mixed. Aliquots of a supernatant solution were periodically sampled using a microsyringe while each vial was stored at room temperature (for example, a temperature of 20° C. to 25° C.), and an analysis was performed using a gas chromatography-flame ionization detector (GC-FID), to verify the degradation rate of DIFP. Results of the analysis are shown in FIGS. 5A through 5D, 6A and 6B. A catalytic degradation process of DIFP is shown by Formula 1 below.

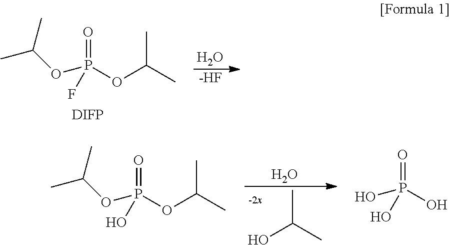

Referring to FIGS. 5A through 5D, it may be confirmed that degradation reaction rates and degradation rates of all Mg(OH)₂-doped MOF materials of Examples 1 to 4 significantly increased in comparison to pure materials that are UiO-66, MOF-808, Ce-UiO-66, and Ce-MOF-808, and that rates of rate-determining steps (RDSs) of degradation reactions using all the Mg(OH)₂-doped MOF materials increased in comparison to those of LiOBu-doped MOF materials. Also, referring to FIGS. 6A and 6B, it may be confirmed that degradation reaction rates of Mg(OH)₂-doped UiO-66 and Mg(OH)₂-doped MOF-808 of Examples 1 and 2 increased in comparison to pure Mg(OH)₂, UiO-66, and MOF-808. In other words, it may be found that in comparison to a result indicating that the pure Mg(OH)₂ did not significantly contribute to a DIFP degradation reaction, a synergy that a degradation rate of DIFP greatly increased by an interaction between MOF and Mg(OH)₂ was shown.

2) GD Decontamination Experiment.

To verify a degradation rate of GD that is a nerve agent, 20 mg of each of the MOFs of Preparation Examples 1 through 4, Examples 1 through 4, and Comparative examples 1 through 4 was added to a 2.0 mL glass vial, 0.5 mL of distilled water was added thereto, and mixed, similar to steps taken for DIFP.

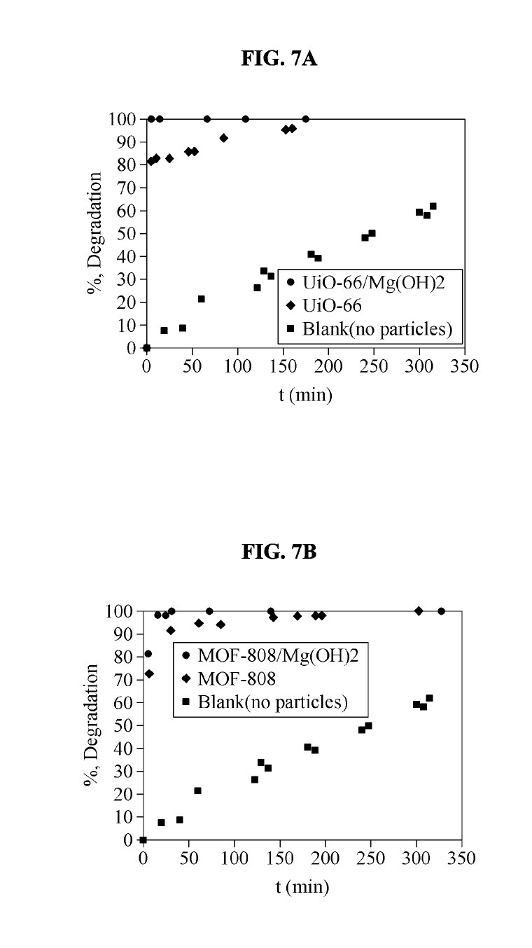

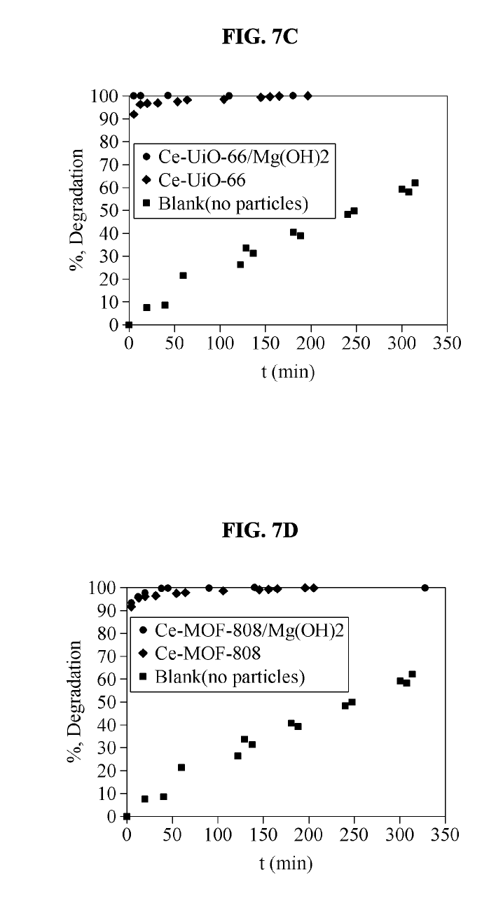

2.5 μl of DMSO as an internal standard material for a GC was added to each vial, and 2.5 μl of GD was spiked using a microsyringe. Thereafter, vortexing using a vortex mixer was performed for about 2 mins until the contents were well mixed. Aliquots of a supernatant solution were periodically sampled using a microsyringe while each vial was stored at room temperature (for example, a temperature of 20° C. to 25° C.), and an analysis was performed using a GC-FID to verify the degradation rate of GD. FIGS. 7A through 7D illustrate a degradation rate of GD of each sample.

Referring to FIG. 7A, it may be confirmed that in a UiO-66/Mg(OH)₂ of Example 1, GD in a solution was degraded by 100% very shortly after the reaction started (within five mins), and thus it may be found that a degradation reaction rate significantly increased in comparison to a blank sample in which reactive particles are absent. Also, it may be confirmed that an effect of increasing a reaction rate is significantly enhanced due to an addition of Mg(OH)₂, in comparison to pure UiO-66 materials. In a case of using the pure UiO-66 materials, a GD degradation rate was about 80% about 10 mins after the reaction started, GD was not completely degraded even after 3 hrs, and unreacted GD amounting to about 5% of an initial amount of GD was detected.

Referring to FIG. 7B, it may be confirmed that initial GD degradation rates by MOF-808 and MOF-808/Mg(OH)₂ that have Zr as central metals in the same manner as that of UiO-66, were reduced in comparison to those by UiO-66/Mg(OH)₂, however, that GD was completely degraded and disappeared after about 30 mins. Also, it may be confirmed that a degradation reaction rate of the MOF-808/Mg(OH)₂ increased due to an addition of Mg(OH)₂ in comparison to that of MOF-808.

Referring to FIGS. 7C and 7D, it may be confirmed that in GD degradation rates by Ce-Uio-66 and Ce-MOF-808 materials in which Ce is used instead of Zr in backbone structures of UiO-66 and MOF-808, degradation reaction rates of Ce-UiO-66/Mg(OH)₂ and Ce-MOF-808/Mg(OH)₂ increased due to an addition of Mg(OH)₂.

3) Experimental Result of VX Hydrolysis

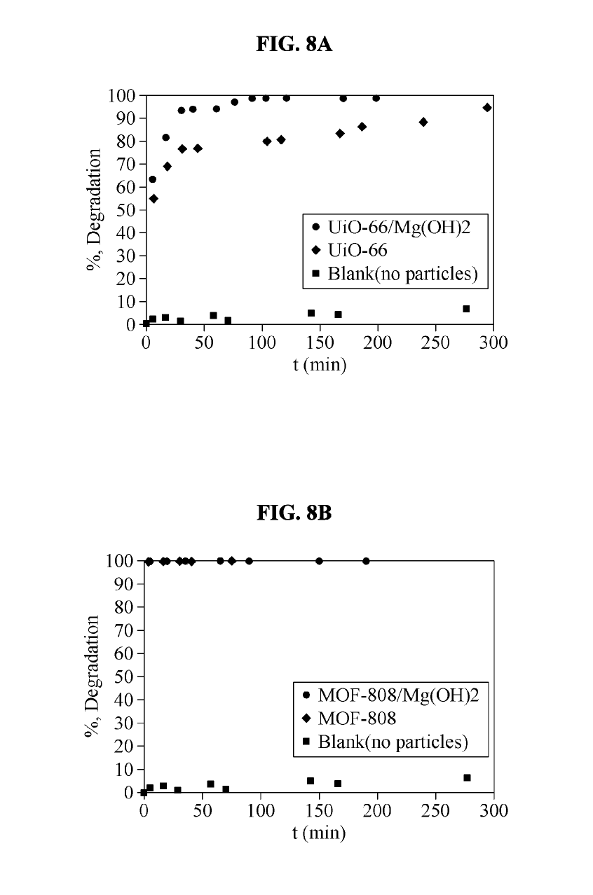

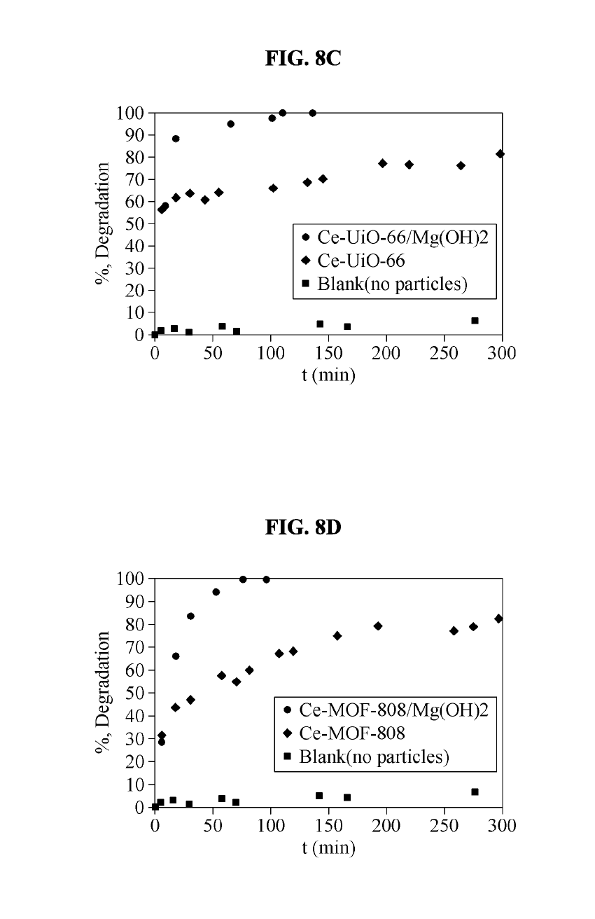

To verify a degradation rate of VX, 20 mg of each of the MOFs of Preparation Examples 1 through 4, Examples 1 through 4, and Comparative Examples 1 through 4 was added to a 2.0 mL glass vial, a mixed solution of 0.5 mL of distilled water and 0.5 mL of ethanol at a ratio of 1:1 was added thereto, and the contents were mixed. 2.5 μl of DMF as an internal standard substance for a GC was added to each vial, and 2.5 μl of VX was spiked using a microsyringe. Thereafter, vortexing using a vortex mixer was performed for about 2 mins until the contents were well mixed. Aliquots of a supernatant solution were periodically sampled using a microsyringe while each vial was stored at room temperature (for example, a temperature of 20° C. to 25° C.), and an analysis was performed using a GC-FID to verify the degradation rate of the VX. FIGS. 8A through 8D illustrate a degradation rate of VX of each sample.

Referring to FIGS. 8A through 8D, it may be confirmed that similar to those of the GD, degradation rates of VX by MOF materials significantly increased in comparison to a blank sample in which a MOF material is absent. Also, it may be found that the degradation rates of the VX further increased when Mg(OH)₂ is added to the MOF materials. It may be confirmed that for Mg(OH)₂-doped MOF-808, a VX degradation reaction rate is relatively greater than an analysis rate, and thus the Mg(OH)₂-doped MOF-808 has a strong capability to degrade all the VX within five mins, regardless of whether Mg(OH)₂ is added, and that a VX degradation reaction was accelerated by doping with Mg(OH)₂.

Also, based on the results of FIGS. 7A through 7D and 8A through 8D, it may be confirmed that UiO-66/Mg(OH)₂ and Ce-UiO-66/Mg(OH)₂ were most excellent in degradation of 3,3-dimethyl-2-butyl methylphosphonofluoridate (GD, or soman), and that MOF-808 and MOF-808/Mg(OH)₂ were most excellent in degradation of O-ethyl S-(2-diisopropylamino)ethyl methylphosphonothioate (VX). For example, when UiO-66/Mg(OH)₂ and MOF-808/Mg(OH)₂ are mixed at a ratio of 1:1, both nerve agents may be expected to be completely degraded by the mixture within 5 mins. Thus, to decontaminate various nerve agents, a CWA decontaminant with a mixture of Mg(OH)₂-doped MOFs according to the present disclosure may be provided.

4) Verification of Degradation Product

As a result of a decontamination efficiency experiment, degradation products were verified using a gas chromatography-mass spectrometry (GC-MS) method. 1 hr after the degradation reaction started, a portion of liquid in a glass vial was sampled, a sample obtained by the sampling was left so that water and ethanol were sufficiently vaporized at room temperature, and a silylation process was performed, to verify the sample. As a result, it was confirmed that O-pinacolylmethylphosphonic acid was a major product in GD, and that O-ethyl methylphosphonic acid (EMPA) was a major product in VX. The major products are known as materials that are almost non-toxic in comparison to GD and VX.

According to example embodiments, a CWA decontaminant may enhance a degradation rate or a degradation reaction rate of a CWA, such as a nerve agent, in comparison to a pure MOF and/or a metallic compound, by applying a MOF doped with a metallic compound.

According to example embodiments, it is possible to provide a CWA decontaminant that may have a decontamination capability to degrade a CWA immediately when the CWA decontaminant is in contact with the CWA at various temperatures, for example, at room temperature, and that may be environmental-friendly since the CWA decontaminant does not have corrosivity, and the like.

Also, the CWA decontaminant may be variously utilized for military and industrial purposes and may be processed in various forms, for example, a granule, a fiber, and the like, so as to be applicable in various fields and to various products.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A chemical warfare agent (CWA) decontaminant comprising:
a metal-organic framework (MOF) comprising at least one metallic compound, the at least one metallic compound being selected from a group consisting of metal hydroxide, metal hydride, metal acetate, metal methoxide, and metal oxide, and being dispersed either on a surface of the MOF or in pores of the MOF, or both.

2. The CWA decontaminant of claim 1, wherein the metallic compound comprises at least one selected from a group consisting of Mg, Ca, Sr, Ba, and Zn.

3. The CWA decontaminant of claim 1, wherein the metallic compound comprises at least one selected from a group consisting of magnesium hydroxide, magnesium hydride, magnesium acetate, and magnesium methoxide.

4. The CWA decontaminant of claim 1, wherein a central metal of the MOF comprises either one or both of an element and an ion of at least one metal selected from a group consisting of Zr, Ce, Fe, Ti, Cu, Hf, V, and Sb.

5. The CWA decontaminant of claim 1, wherein the MOF comprises at least one selected from a group consisting of MOF-808, NU-1000, UiO-66, UiO-66-X, in which X is NH₂, NO₂, or (OH)₂, UiO-67, and UiO-67-X in which, wherein X is NH₂, NO₂, or (OH)₂.

6. The CWA decontaminant of claim 1, wherein the metallic compound is present in an amount of 1 through 50 parts by weight based on 100 parts by weight of the MOF.

7. The CWA decontaminant of claim 1, wherein a CWA comprises at least one selected from a group consisting of soman, tabun, sarin, cyclosarin, O-ethyl S-(2-diisopropylamino)ethyl methylphosphonothioate (VX), parathion, paraoxon, malathion, and derivatives thereof.

8. The CWA decontaminant of claim 1, wherein the CWA decontaminant degrades a CWA that is in a liquid phase or a gas phase at a temperature of 0° C. to 200° C.

9. A method of preparing a CWA decontaminant, the method comprising:
preparing a metallic compound solution by mixing a metallic compound and a solvent;
preparing an MOF suspension by mixing an MOF and a solvent;
mixing the metallic compound solution and the MOF suspension; and
separating a powder from a mixture obtained by the mixing of the metallic compound solution and the MOF suspension and drying the powder.

10. The method of claim 9, wherein each of the solvents comprises at least one selected from a group consisting of water, acetone, benzyl alcohol, methanol, ethanol, isopropanol, n-propanol, n-butanol, tert-butanol, acetonitrile, ether, N-methyl-2-pyrrolidone (NMP), dimethylformamide (DMF), dimethylacetamide (DMAc), xylene, benzene, chloroform (CHCl₃), toluene, tetrahydrofuran (THF), glycerin, ethylene glycol, dimethylpyrrolidone, cyclohexane, and dimethyl sulfoxide.

11. A composition of a CWA decontaminant, the composition comprising:
a CWA decontaminant; and
a solvent,
wherein the CWA decontaminant comprises an MOF that comprises at least one metallic compound that is selected from a group consisting of metal hydroxide, metal hydride, metal acetate, metal methoxide, and metal oxide and that is dispersed either on a surface of the MOF or in pores of the MOF, or both.

12. A product comprising the composition of a CWA decontaminant of claim 11.

13. The product of claim 12, wherein the product is a gas mask canister or a gas filter of collective protection equipment.

14. The product of claim 13, wherein the product is formed of a fiber.

15. The product of claim 14, wherein the fiber is combined with the composition of the CWA decontaminant by either one or both of impregnating the fiber with the composition of the CWA decontaminant and coating the fiber with the composition of the CWA decontaminant.
